(19) United States
(12) Patent Application Publication
(10) Pub. No.: US 2012/0308308 A1
(43) Pub. Date: Dec. 6, 2012

(54) FOUNDATION SUPPORT INSTALLER

(76) Inventor: Thomas C. Stewart, Charleston, WV (US)

(21) Appl. No.: 13/152,368

(22) Filed: Jun. 3, 2011

(51) Int. Cl. F16M 3/00; E02D 27/00; F16M 13/02

(52) U.S. Cl. 405/229; 248/664; 248/660

(57) ABSTRACT

An apparatus and carriage therefore for installing a foundation support such as a helical anchor or pier. One embodiment includes a base, a boom, and a carriage. The carriage may include a carriage frame and a mount pivotably connected to the carriage frame. The mount may include a rotatable ring in which a motor drive unit may be attached.

### FIELD OF THE INVENTION

This invention is related to structural support for homes and other buildings, and more particularly to a device for installing foundation supports such as helical anchors and piers through structures such as foundation walls and footings.

### BACKGROUND OF THE INVENTION

Foundation walls and footings are subject to various gravitational and lateral pressures from surrounding earth, including those from water, soil settlement and other movement, and expanding clay. To counteract those forces and repair walls and footings damaged by them, foundation supports such as anchors and piers may be installed. Anchors, such as helical anchors, may be installed through foundation walls and into bearing soil or other earth to support the walls against cracking, bowing, and buckling. Piers, such as helical piers, may be installed through footings, such as to counteract destabilizing forces due to earthen movement. Various machinery may be used to impart the torque needed to rotationally advance the foundation supports through the foundational structure and earth. The installed maximum torque determines the pullout strength of the installed anchor or pier.

Because that torque can be large, foundation supports are commonly driven by heavy machinery such as skid-steer loaders or mini-excavators equipped with hydraulic anchor drive head tools. However, installation sites with limited space or access may render the use of such machinery inconvenient or impossible. In those cases, the “hand held” method of installing foundation supports may be used. In that method, a yoke assembly or frame is bolted to a hydraulic drive head that supplies the rotational force necessary to drive the anchor or pier. The yoke is connected to a torque bar that counters the rotational force generated by the drive head. The entire assembly is then lifted into the desired installation position for the anchor or pier and supported or cradled by the brute strength of the installers. Hydraulic motor control is provided by a foot controlled spool valve.

However, the hand held method of installing foundation supports is labor intensive, imprecise, and often dangerous. For example, installing a helical anchor or pier using that method commonly employs five or six people. Even with such manpower, though, the mass of the assembly renders the attainment of the attitude and directional control necessary for proper installation difficult. Additionally, unbuffered movement of the assembly and proximity of the installers present many hazards related to loss of control. The floor positioned spool valve and gauge assembly is a trip hazard and accidental engagement can cause the unintended start of the hydraulic motor. The foot pedal hydraulic gauges also become difficult to monitor to attain the proper installed torque requirements.

Therefore, there may be a need for an apparatus and method for installing foundation supports such as helical anchors and piers that are less labor intensive and dangerous, and more precise, than the hand held method.

There may also be a need for an improved apparatus and method for installing foundation supports such as helical anchors and piers at sites of limited space or access, or otherwise where use of heavy and large installation equipment is not feasible or practical.

### SUMMARY OF THE INVENTION

The present invention is directed to systems, methods and apparatuses for foundation support installation. In accordance with one form of the present invention, a foundation support installer includes a base, a boom, and a carriage. The carriage may include a carriage frame and a mount. The mount may be pivotably connected to the carriage frame.

In another embodiment, a carriage for a foundation support installer includes a carriage frame and a mount pivotably connected to the carriage frame, the mount including a mount frame and a ring adjacent to the mount frame.

Accordingly, the present invention provides solutions to the shortcomings of prior foundation support installation systems and methods. Those of ordinary skill in foundation support installation will readily appreciate, therefore, that those details described above and other details, features, and advantages of the present invention will become further apparent in the following detailed description of the preferred embodiments of the invention.

### BRIEF DESCRIPTION OF THE DRAWINGS

The accompanying drawings, wherein like reference numerals are employed to designate like components, are included to provide a further understanding of foundation support installers, are incorporated in and constitute a part of this specification, and illustrate embodiments of foundation support installers that together with the description serve to explain the principles of foundation support installers.

Various other objects, features and advantages of the invention will be readily apparent according to the following description exemplified by the drawings, which are shown by way of example only, wherein:

FIG. 1 illustrates a perspective view of an embodiment of a foundation support installer;

FIG. 2 illustrates a front view of the carriage of the foundation support installer of FIG. 1 in the lower mounting position, in accordance with an embodiment;

FIG. 3 illustrates a front view of the carriage of the foundation support installer in the upper mounting position, in accordance with one embodiment;

FIG. 4 illustrates a perspective view of an embodiment of a foundation support installer in a vertical installation position;

FIG. 5 illustrates a perspective view of an embodiment of a foundation support installer in a position for installing a foundation support at an angle; and

FIG. 6 illustrates a perspective view of an embodiment of a foundation support installer with an electronic torque monitor.

### DETAILED DESCRIPTION

Reference will now be made to embodiments of foundation support installers, examples of which are illustrated in the accompanying drawings. Details, features, and advantages of the foundation support installers will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

As used herein, to “pivot” means to turn about an axis. The axis may be defined, for example, by a pin or bolt to which the thing that pivots is connected. When a first thing is “pivotably connected” to another, the first thing is connected in such a way, e.g., by a pin or bolt, that allows that first thing to pivot relative to the other. The pivotable connection may be such that the first thing can pivot about more than one axis, such as when the connection is by way of the U-shaped connector 210. In any case, being “pivotably connected” does not necessarily mean that the first thing can freely pivot about the other thing. Rather, a pin or bolt (e.g., bolt 250 connecting U-shaped connector 210 and carriage 300) may have to be loose or loosened to allow pivoting with minimal force. Likewise, a locking or retaining quick-release or other pin (e.g., retaining quick-release pin 380 to prevent pivoting of the mount 340 of the carriage 300) may be installed and thereby prevent pivoting and have to be removed to allow the pivoting.

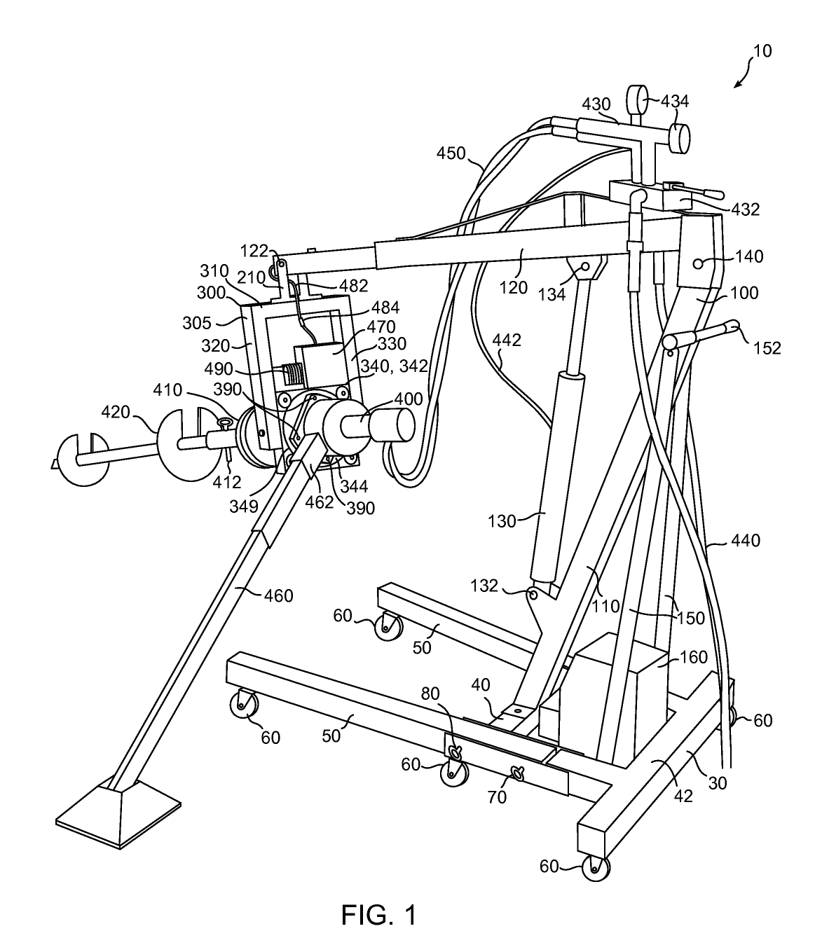

FIG. 1 illustrates a perspective view of a foundation support installer 10, in accordance with one embodiment. The foundation support installer 10 may be used to install a foundation support through a foundation wall or footing and into soil or other earth. As used herein, a “foundation support” is an anchor such as a helical anchor, a pier such as a helical pier, a pile such as a helical pile, an anchor or pier or pile extension, a threaded rod adapter that may be fitted on an anchor or pier or pile extension and allows a bearing wall plate to be attached, or other element that may be installed through a foundation wall, footing, or other structure and into soil or other earth to provide structural support and/or retention. The foundation support may include a round, square, or other-shaped shaft and, in the case of helical anchors, piles, or piers, for example, may have include differing numbers of attached helices. The foundation support installer 10 may position the foundation support horizontally, vertically, or at an angle between the horizontal and vertical as well as at a lateral angle and facilitate installation of the foundation support, such as described below.

The foundation support installer 10 embodiments described herein provide a portable, precision-oriented mechanical means alternative to the “hand held” method for installing foundation supports such as helical anchors and piers. The foundation support installer 10 may be small enough and able to be at least partially disassembled to allow its transportation to limited access spaces, unlike heavy machinery such as skid-steer loaders or mini-excavators equipped with hydraulic anchor drive head tools. Additionally, installation using the foundation support installer 10 may be less labor intensive and dangerous and more precise than the hand held method. The foundation support installer 10 may be operated by a two-man crew, may withstand the torque generated in driving a foundation support through a wall or foundation and into earth, and may provide steady installation of foundation supports that may reduce or eliminate soil cavitation.

The foundation support installer 10 may include a base 30, a boom 100, and a carriage 300. The boom 100 may extend from the base 30. The base 30 may include a base frame 40 and legs 50 and may provide a support structure of the foundation support installer 10. The base frame 40 may include square tube steel and be rectangular in shape if desired. A multiplicity of rollers 60 may be attached underneath the base 30. For example, four rollers (two shown, as 60) may be positioned under the base frame 40, two under the back rail 42 of the base frame 40 and one under the area where the legs 50 may pivot when folding, as described below. Two additional rollers 60 may each be positioned under a leg 50. The rollers 60 may be large steel casters or other rollers 60.

Each leg 50 may be foldable such that it is connected to the base frame 40 by a pin (one shown, as 70) about which the leg 50 may pivot. A pin (one shown, as 80) may be inserted through each leg 50 and the base frame 40 when that leg 50 is down (as shown) to lock that leg 50 and thus prevent it from pivoting during operation of the foundation support installer 10. In other embodiments, other pivotable members may be substituted for the pins (one shown, as 70) and other means for securing the legs 50 may be substituted for the other pins (one shown, as 80).

The boom 100 may include a boom support 110 and boom lift member 120, and, in an embodiment, a hydraulic lift cylinder 130. The boom lift member 120 may be connected to the top of the boom support 110 by a pivotable connection 140, such as a pin, for example. The boom support 110 may provide an upright column support for the boom lift member 120. Reinforcement straps 150 may be connected at their ends to the base frame 40 and boom support 110 to provide upright column support to the boom support 110.

The hydraulic lift cylinder 130 may be pivotably or otherwise connected at its ends to the boom support 110 and boom lift member 120. Those pivotable connections may be a welded bracket 132 on the boom support 110 and a welded bracket 134 on the underside and near the back of the boom lift member 120. The hydraulic lift cylinder 130 may operate by hydraulic pressure, such as by a piston-cylinder arrangement or otherwise, to raise and lower the boom lift member 120. In an embodiment, the hydraulic lift cylinder 130 is controlled by the controls 430. The controls 430 for the hydraulic motor drive unit 400 may be attached to the boom lift member 120 or another portion of the boom 100 as desired. The controls 430 may include a spool valve. In an embodiment, the controls 430 include a two spool valve 432, one valve of which may be used to control hydraulic pressure from a fluid supply source (not shown) by way of hydraulic fluid supply hoses 440 to the hydraulic lift cylinder 130, such as by connection to the hydraulic lift cylinder 130 with a one-quarter inch pressure supply hose 442. The hydraulic fluid supply hoses 440 may connect to the two spool valve 432 by input and output quick connect couplings or by another means. The fluid supply source may be an auxiliary hydraulic “power pack” or another hydraulic pressure source. The controls 430 may include gauges 434 that provide forward and reverse pressure readings. Other means for moving the boom lift member 120 may be employed if desired.

The foundation support installer 10 may include a double-ended or other handle 152 that may be attached to an upper region of the boom support 110. The handle 152 may be gripped to position the lift.

The foundation support installer 10 may include a battery 160, which may be encased if desired. The battery 160 may connect to, and power, an onboard electric winch 470, as described below. The battery 160 may be bolted or otherwise attached to the base frame 40 of the base 30 and/or the boom support 110, or may be otherwise connected to the foundation support installer 10. The battery 160 may be 12 volts or another voltage as desired.

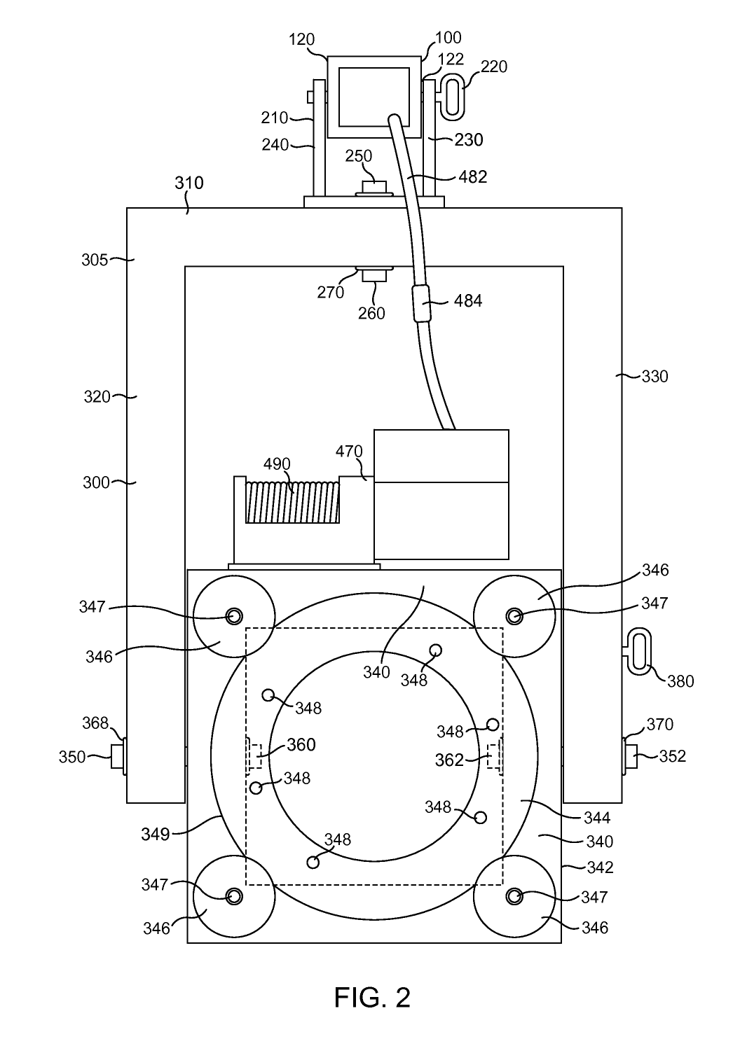

FIG. 2 illustrates a front view of the carriage 300 of the foundation support installer 10 of FIG. 1. The carriage 300 may include a carriage frame 305 and a mount 340. The carriage frame 305 may include a crossbar 310 and arms 320 and 330. The carriage 300 may support, as shown in FIG. 1, a hydraulic motor drive unit 400, motor drive tool 410, and a foundation support 420 to be installed. In an embodiment, the hydraulic motor drive unit 400, such as shown in FIG. 1, may be operated by controls 430.

As described above, in an embodiment, the controls 430 may include a two spool valve 432, one of which may control the hydraulic lift cylinder 130 and thus control the height of the boom lift member 120, carriage 300, and any attached foundation support 420. The second valve may control hydraulic pressure to drive the hydraulic motor drive unit 400. The second valve may be connected via a quick-release coupling at its pressure ports to the hydraulic fluid supply hoses 440 described above and also to hydraulic fluid supply and return lines 450 connecting to the hydraulic motor drive unit 400. The second valve may be used to control of the hydraulic motor drive unit 400 (and thus the same movement of any foundation support 420 attached thereto via the motor drive tool 410 to operate forward, in reverse, and stop or hold, for example.

As described above, the controls 430 may include gauges 434 that provide forward and reverse pressure readings. These gauges 434 may be used in conjunction with a pressure/torque chart to determine the net pressure to be provided to the hydraulic motor drive unit 400 to install the foundation support 420. The net pressure used during installation of the foundation support 420, such as a helical anchor or pier, may be matched to a pressure/torque chart that may be provided by the hydraulic motor drive unit 400 manufacturer, for example, may provide an installed torque value for that foundation support 420 installed.

Other means for controlling the hydraulic motor drive unit 400 may be used if desired. One embodiment of the operation of the hydraulic motor drive unit 400 in conjunction with operation of the rest of the foundation support installer 10 to drive a foundation support 420 is described below. The controls 430 for the hydraulic motor drive unit 400 may be attached to the boom lift member 120 or another portion of the boom 100 as desired.

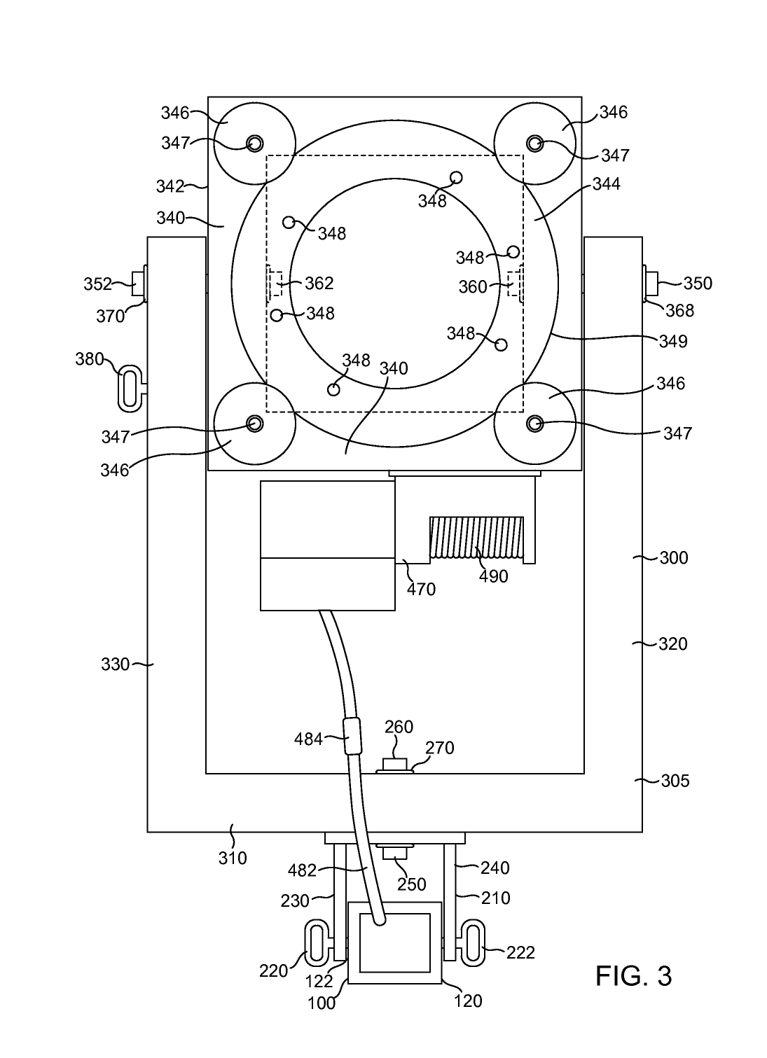

Referring to FIGS. 1 and 2, the carriage 300 may be pivotably connected to the boom 100, such as at an end 122 or another portion of the boom lift member 120. For example, in an embodiment, the carriage 300 includes a U-shaped connector 210 and is pivotably connected to the boom 100 at the boom lift member 120 by the U-shaped connector 210. The U-shaped connector 210 may connect to the boom lift member 120 by a quick-release pin 220 that extends through, as referenced in FIGS. 2 and 3, the arms 230 and 240 of the U-shaped connector 210 and boom lift member 120. The carriage 300 may connect to the U-shaped connector 210 via a bolt 250, which extends through the crossbar 310 of the carriage 300, and a fastener such as a locknut 260 if the bolt 250 is threaded. One or more spacers may be used in that connection arrangement, such as a spacer 270 positioned between the locknut 260 and crossbar 310.

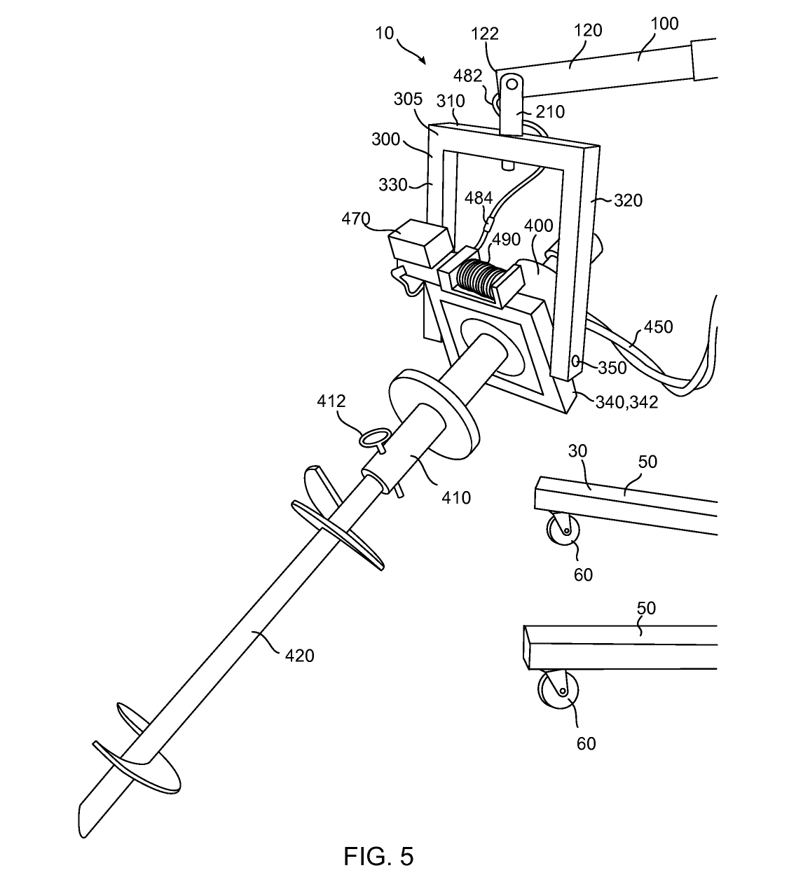

The carriage 300 may pivot about the bolt 250 and may pivot 360 degrees about the axis defined by the bolt 250. As thus pivotably connected, the carriage 300 may rotate 360 degrees about the axis defined by the bolt 250. Allowing this 360 degree rotation may provide flexibility in installing a foundation support 420 at different angles relative to the orientation of the boom 100 and thus the boom lift member 120. In one example shown in FIG. 5, described below, the carriage 300 has been pivoted about the bolt 250 (shown in, e.g., FIG. 2) relative to the position of the carriage 300 shown in, for example, FIGS. 1 and 2.

The carriage 300 may also pivot about the quick-release pin 220 in an embodiment. Thus, in an embodiment in which the U-shaped connector 210 is used to connect the carriage 300 with the boom 100 at the boom lift member 120, this connection is a pivotable connection such that the carriage 300 is pivotable about at least one axis defined by the bolt 250. In an embodiment, the U-shaped connector 210 is a pivotable connection such that it is pivotable about two axes, including the aforementioned axis defined by the bolt 250 and a second axis defined by the quick-release pin 220. In other embodiments, the carriage 300 may be pivotably connected to the boom 100 by means other than the U-shaped connector 210.

Additionally, FIG. 3 shows a front view of the carriage 300 positioned in the vertical position, or upper mounting position, such that the carriage 300 has been removed from the boom lift member 120 by removal of the quick-release pin 220 and reattached via the quick-release pin 220 above the boom lift member 120. Alternatively, the carriage 300 may be repositioned to the upper mounting position by being pivoted about the quick-release pin 220. In an embodiment, a locking quick-release pin 222 may be inserted through the U-shaped connector 210 and possibly the boom lift member 120 to prevent pivoting about the quick-release pin 220 to hold the carriage in the upper mounting position. This position may allow installation of a foundation support 420, such as a helical tie-back anchor, in a part of a wall higher than that allowed when the carriage 300 is positioned in the suspended position shown in FIGS. 1 and 2.

The mount 340 of the carriage 300 may include a mount frame 342 and a ring 344 adjacent to the mount frame 342. The mount 340 may also include multiple (such as four in one embodiment) bearings 346 that may be attached to the mount frame 342, such as by bolts 347, as referenced in FIGS. 2 through 4. In an embodiment, the mount frame 342 is made of square steel tubing welded in a square or other rectangular shape, though in other embodiments the shape of and material in which the mount frame 342 is made may be different.

The ring 344 may be a thin member having an annulus shaped cross-section. The ring 344 may have one or more holes therein, such as six holes 348 in an embodiment as referenced in FIGS. 2 and 3, to enable attachment of a hydraulic motor drive unit. For example, in an embodiment, the hydraulic motor drive unit 400 may be attached to the ring 344 through its six holes 348 by bolts, three bolts 390 of which are referenced in FIG. 1. Also as shown in, e.g., FIG. 1, the motor drive tool 410 may be attached to the hydraulic motor drive unit 400. The motor drive tool 410 may hold the foundation support 420 to be installed, such as by quick-release pin 412 or by another means.

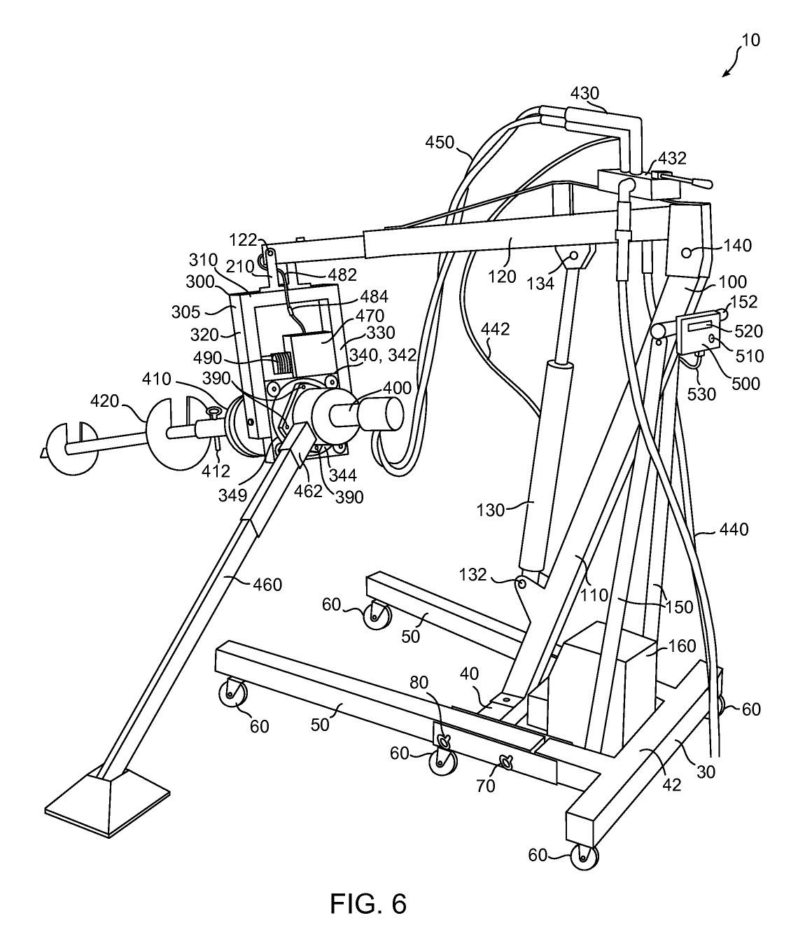

The ring 344 may be rotatable with respect to the mount frame 342. The ring 344 may be aligned by and rotate through contact with the bearings 346 in an embodiment. The ring 344 may be able to rotate a full 360 degrees through such contact. Such rotational capability may provide flexibility in the positioning of the hydraulic motor drive unit 400 and, where attached thereto, the motor drive tool 410 and foundation support 420. For example, in some cases, it may be necessary for the hydraulic motor drive unit 400 and a torque bar 460 attached thereto to pivot as the boom lift member 120 of the boom 100 is raised or lowered. Such rotational capability also allows for the torque bar 460 shown in FIG. 1 to be positioned on either the right or left side of the foundation support installer 10 depending upon site conditions encountered. The hydraulic motor drive unit 400 may have a torque bar attachment bracket 462, referenced in, e.g., FIGS. 1 and 6, bolted to its back end or back side, such as through three mounting holes (not shown) or another means, to attach the torque bar 460.

In an embodiment, the bearings 346 include four V-guide bearings as shown, each positioned at a different corner of the mount frame 342 and each attached thereto by a bolt 347. The V-guide bearings may rotate as they contact the ring 344 and align and allow rotation of the ring 344. In this embodiment, the outer edge 349 of the ring 344 may be beveled to more accurately align with the grooves of the V-guide bearings. The bevel may be 45 degrees or another angle. The V-guide bearings may constrain the ring 344 to an interior area of the mount frame 342, such as the central area in which the ring 344 is shown.

The mount 340 may be pivotably connected to the carriage frame 305. For example, in an embodiment and as referenced in, e.g., FIGS. 2 and 3, the mount 340 is pivotably connected to the arms 320 and 330 of the carriage frame 305 by bolts 350 and 352 that extend through holes in the arms 320 and 330, respectively, and further extend through the mount frame 342 of the mount 340. The bolts 350 and 352 may be fastened, such as by locknuts 360 and 362, respectively, if the bolts 350 and 352 are threaded. One or more spacers may be used in that connection arrangement, such as spacers 368 and 370.

As pivotably connected to the carriage frame 305, the mount 340 may rotate 360 degrees about the axis defined by the bolts 350 and 352. In an embodiment, the axis defined by the bolts 350 and 352 may be substantially perpendicular to the axis defined by the bolt 250 such that the mount 340 may pivot about an axis perpendicular to at least one axis about which the carriage frame 305 pivots. Thus, subject to interference by the boom 100 and other parts of the foundation support installer 10 as well as the hydraulic motor drive unit 400, motor drive tool 410, foundation support 420 described below, and/or any other element connected to the carriage 300, those two pivotable connections allow the foundation support 420 and/or any other element connected to the carriage 300 to be oriented in any way among all three dimensions.

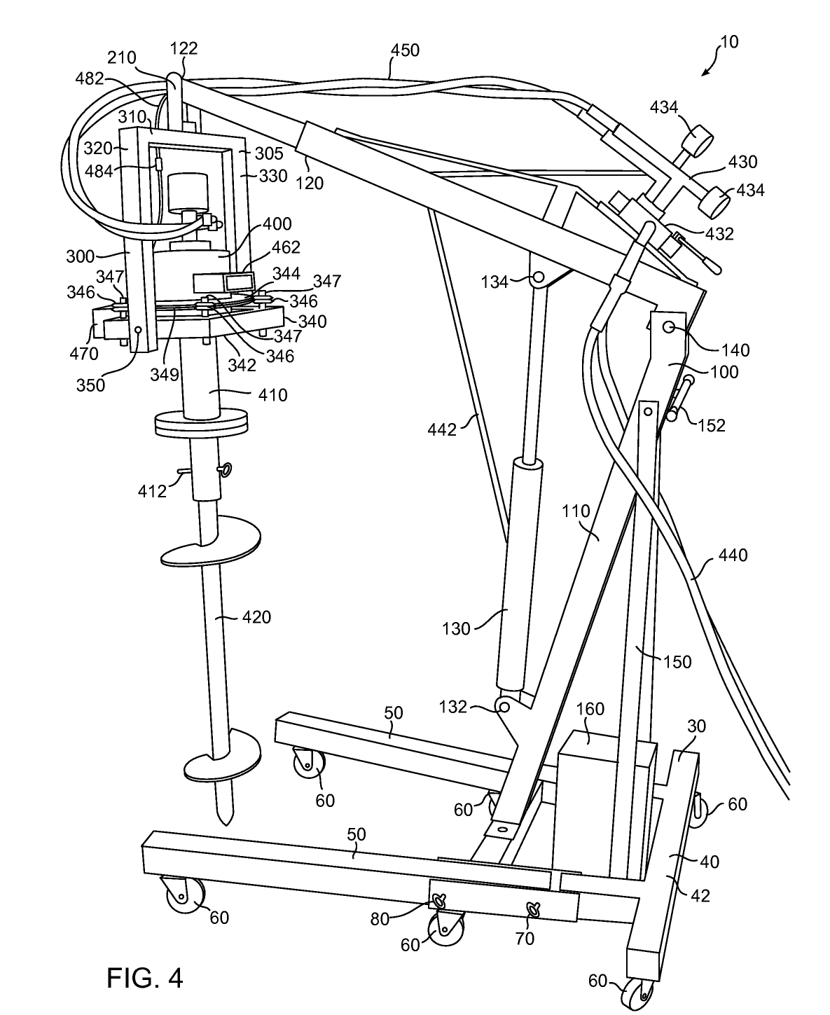

In one embodiment, the carriage 300 includes a mount quick-release retainer pin 380. The mount quick-release retainer pin 380 may extend through a drilled hole or other opening in the arm 330 of the carriage frame 305 and further extend into the mount 340. The mount quick-release retainer pin 380 may prevent pivoting of the mount 340, and thus the mount frame 342, when pivoting is not desired. The mount quick-release retainer pin 380 may be removed to allow pivoting of the mount 340 to orient the attached foundation support 420 to a desired angle to be installed, such as the vertical pier or pile installation position shown in FIG. 4 or the position shown in FIG. 5.

The carriage 300 may also comprise an electric winch 470, which may be attached to the mount frame 342 and thus the mount 340, such as by one or more bolts. The electric winch 470 may operate to supply a constant or nearly constant pressure that translates to the foundation support 420 during installation to decrease or prevent soil cavitation. The electric winch 470 may be DC-powered. The electric winch 470 may be connected to the battery 160 shown in FIG. 1 by a circuit breaker or fuse (not shown), such as a 30 amp fuse, and power cable 482 with a winch electrical harness connector 484. The electric winch 470 may be attached via its cable 490 and end cable hook (not shown) to a D-ring or other hook anchored to a wall just above an access hole in the wall or foundation or other structure in which the foundation support 420 is to be installed, as described below.

The foundation support installer 10 may be employed to facilitate installation of a foundation support, such as in a hole that has been drilled in a foundation wall to reinforce the wall's surface. If pathways to the installation site are cramped, the foundation support installer 10 may be at least partially disassembled into sub-assemblies if desired to facilitate maneuvering. For example, the boom 100 and reinforcement straps 150 may be detached from the base 30 and the legs 50 may be folded to facilitate maneuvering through standard doorways, halls, and stairways. Such features may also ease loading and unloading into a transportation vehicle.

For example, the carriage 300 of the foundation support installer 10 may be positioned in the lower mounting, or suspended, position shown in FIGS. 1 and 2. This position may be used to install a foundation support 420 such as a tie-back anchor, which may be a helical anchor, through a low to middle height of a foundation wall. As described above, if the helical anchor or other foundation support 420 is to be installed through a foundation wall at a middle to upper height, the carriage 300 may be removed by removal of the quick-release pin 220, reoriented, then reconnected by the quick-release pin 220 above the boom lift member 120. In either case, and as described above, the hydraulic motor drive unit 400 may be attached to the ring 344 of the mount 340, and the motor drive tool 410 may be attached to the hydraulic motor drive unit 400. The foundation support 420 may be coupled with the motor drive tool 410, such as by the quick-release pin 412 or another means. If desired, the height of the carriage 300 and the foundation support 420 it is carrying may be further adjusted by using the controls 430, as described above, to raise or lower the boom lift member 120 and its end 122.

In other embodiments, the height and angle of the foundation support 420 may be alternatively adjusted. For example, FIG. 4 illustrates a perspective view of an embodiment of a foundation support installer 10 in a position for vertically installing a foundation support 420 that may be a helical pier or pile. In this embodiment, the controls 430 have been used to raise the boom lift member 120 and its end 122 above its position shown in FIG. 1. Additionally, the mount 340, and thus the mount frame 342, has been pivoted in FIG. 4 such that when the hydraulic motor drive unit 400, the motor drive tool 410, and foundation support 420 are secured together and with the carriage 300 as described herein, the foundation support 420 will be angled downward for vertical installation, such as through a foundation and into earth below.

FIG. 5 illustrates a perspective view of an example of another height and angle at which the foundation support installer 10 may be set for installing a foundation support 420. In that figure, the angle in which the foundation support 420 is positioned has been adjusted by both pivoting the carriage 300, and thus the carriage frame 305, about its bolt 250 (e.g., shown in FIG. 2) and further pivoting the mount 340, and thus the mount frame 342, downward. This and other positioning may be accomplished to accommodate space constraints, such as by adjusting the height of the end 122 of the boom lift member 120, pivoting the carriage about the quick-release pin 220 and/or bolt 250, and pivoting the mount 340 about the bolts 350, 352. Those adjustments as well as others described herein may allow orientation of the foundation support 420 in any direction (subject to interference by the boom 100 and/or other parts of the foundation support installer 10) at various heights.

In various embodiments, one or more parts of any of the foundation support installers herein may be replaced by one or more alternative parts as desired. For example, FIG. 6 illustrates a perspective view of an embodiment of the foundation support installer 10 as in previous figures, but with an electronic monitor 500 in place of the gauges 434. The electronic monitor 500 may be connected to the two spool valve 432, for example, to electronically monitor the differential pressure used during installation of the foundation support 420 and the installed torque value for the foundation support 420. The electronic monitor 500 may include an actuator 510 such as a knob or set of buttons, a display 520, and a power cable 530 that may connect to the battery 160 or another power source for powering the electronic monitor 500 or charging an internal battery. The actuator 510 may be used to toggle between displaying, on the display 520, forward pressure readings, reverse pressure readings, differential pressure, and installed torque value, for example.

After the hydraulic motor drive unit 400, the motor drive tool 410, and foundation support 420 are secured together and with the carriage 300 in a desired position such as one shown and described herein, the foundation support installer 10 may be rolled along its rollers 60 into a desired alignment. For example, the foundation support installer 10 may be aligned such that the foundation support 420 it is carrying is positioned close to and aligned with an access hole of a wall or foundation.

As described above, the electric winch 470 may then be attached via its lead cable 490 and end cable hook (not shown) to a D-ring or other hook anchored to the wall or foundation just above the access hole. The D-ring or other hook may be anchored to the wall or foundation with concrete sleeve anchors or another means of attachment. The winch may be engaged by remote control (not shown) or other means to pull the winch cable taught. The cable tension may urge the lead point of the foundation support 420 through the access hole in the wall or foundation and into the exposed soil bank behind. The cable tension may allow the foundation support 420 to readily advance without causing, or decreasing, cavitations in the soil.

The torque bar 460 may then be attached to the torque bar attachment bracket 462 bolted to the back of the hydraulic motor drive unit 400 and have its end rest on the floor or other adjacent support. The torque bar 460 may counter the rotational torque of the hydraulic motor drive unit 400 motor when operating during installation of a foundation support 420. Thus, as the hydraulic motor drive unit 400 operates to rotate the helical anchor or other foundation support 420 clockwise through the wall or foundation and into the soil, a counter rotational force may be transferred through the torque bar 460 and to the floor or support. The torque bar 460 may thereby prevent the opposing rotational force to be transferred to the boom lift member 120 and through to the rest of the boom 100 and base 30.

To operate the hydraulic motor unit, causing the hydraulic motor drive unit 400 motor to rotate, the second valve of the two spool valve 432 of the controls 430 may be opened using the gauges 434. When the foundation support 420 is a helical anchor, for example, the motor rotation may thereby rotate the anchor and its helices, which will enter the access hole and penetrate the soil bank face. The actuation of the electric winch 470 may be coordinated with the advancement of the helical anchor to provide constant or nearly constant tension on the electric winch 470 cable 490. Once the helical anchor penetrates the soil, its rotational advancement becomes self-feeding as its helices rotate into the soil. The cable 490 pressure, which may be transferred to the back of the helical anchor through the foundation support installer 10, may cause the advancement of the helices into the varying soil layers to be steady, limiting or eliminating cavitations therein. The torque bar 460 resting on the floor or other support may be periodically advanced to keep it perpendicular to the drive line of the foundation support installer 10.

Advancement of the helical anchor may continue until the motor drive tool 410 reaches the face of the wall. The motor drive tool 410 may then be released from the helical anchor and the cable 490 of the electric winch 470 may be released from the D-ring or other hook. The foundation support installer 10 may be rolled back away from the wall, such as to a point approximate to the length of an extension to the helical anchor to be installed.

Multiple extensions may be used in succession to further advance the lead, helical anchor to further engage the bearing soils. The first extension may be bolted to the lead, helical anchor and connected to the motor drive tool 410 via the quick-release pin 412 or other method used to couple the helical anchor to the motor drive tool 410. The electric winch 470 cable 490 may be reaffixed to the D-ring or other hook and pre-tensioned to promote advancement of the lead, helical anchor and extension. The hydraulic motor drive unit 400 and electric winch 470 controls may again be engaged to advance the lead, helical anchor further into the earth, ultimately to contact the bearing strata beyond.

During the installation of the lead, helical anchor and extensions, the gauges 434 of the controls 430 may be monitored to attain the site-specified net pressure levels that represent the final installed torque of the lead, helical anchor. Upon attainment of the desired installed torque, the motor drive tool 410 may be uncoupled from the last extension. The foundation support installer 10 may again be repositioned to an appropriate position to fit the last extension with a threaded rod adapter that allows a bearing wall plate to be attached. The threaded rod adapter may then be coupled with the motor drive tool 410, and the hydraulic motor drive unit 400 may operate to advance the threaded rod adapter to the face of the wall. The foundation support installer 10 may then be pulled away from the threaded rod adapter and wall face. The threaded rod adapter may be connected to an all-thread rod that extends through the bearing wall plate and may be permanently affixed with a nut and washer. The nut may be tightened to a specified torque, completing installation of a tie-back anchor assembly. The foundation support installer 10 may then be readied for another tie-back anchor assembly installation.

Installation of a helical pier or pile assembly, including extensions and adapters, for example, may be accomplished similarly to that of the tie-back anchor assembly. The vertical pier or pile installation position illustrated in FIG. 4 may be used to install a helical pier or pile assembly, for example. Other installation positions, such as the position shown in FIG. 5, may be used to install assemblies of other foundation supports 420.

After all foundation supports 420 have been installed, the foundation support installer 10, if desired, may be at least partially disassembled into sub-assemblies and the legs 50 may be folded for ease of loading and to facilitate maneuvering through standard doorways, halls, and stairways.

The foundation support installer 10 embodiments herein each provide a portable device for installing foundation supports, such as helical anchors and piers, in limited access spaces while being less labor intensive and dangerous and more precise and reliable than the hand held method. The foundation support installer 10 may separate the crew from the hydraulic motor 400 and torque bar 460 as compared to the hand held method to provide a “set-back” or “safety zone” around the hydraulic motor drive unit 400 and the strong rotational forces it imparts to the foundation support 420. The foundation support installer 10 may resist the torque generated to facilitate the controlled and repeatedly accurate installation of foundation supports 420.

While specific embodiments of the invention have been described in detail, it should be appreciated by those skilled in the art that various modifications and alternations could be developed in light of the overall teachings of the disclosure. Accordingly, the particular arrangements, apparatuses, systems, and methods disclosed are meant to be illustrative only and not limiting as to the scope of the invention.

What is claimed is:

1. A carriage for a foundation support installer, comprising:
a carriage frame; and
a mount pivotably connected to the carriage frame, the mount comprising a mount frame and a ring adjacent to the mount frame.

2. The carriage of claim 1, wherein the carriage frame comprises a crossbar and two arms extending from the crossbar.

3. The carriage of claim 2, further comprising a quick-release retainer pin to extend through at least one of the two arms and further to extend into the mount frame.

4. The carriage of claim 2, further comprising a U-shaped connector attached to the crossbar.

5. The carriage of claim 2, wherein the mount is pivotably connected to the two arms of the carriage frame.

6. The carriage of claim 1, further comprising multiple bearings attached to the mount frame, the ring aligned by the multiple bearings.

7. The carriage of claim 6, wherein the multiple bearings comprise four V-guide bearings.

7. The carriage of claim 1, the ring comprising an outer edge, and wherein the outer edge is beveled.

8. The carriage of claim 1, wherein the ring is rotatable with respect to the mount frame.

9. The carriage of claim 1, further comprising an electric winch attached to the mount frame.

10. The carriage of claim 1, wherein the ring comprises one or more holes therein to enable attachment of a hydraulic motor drive unit to the ring.

11. A foundation support installer, comprising:
a base;
a boom; and
a carriage comprising a carriage frame and a mount, the mount pivotably connected to the carriage frame.

12. The foundation support installer of claim 11, the carriage pivotably connected to the boom.

13. The foundation support installer of claim 11, the boom comprising a boom lift member, the carriage pivotably connected to the boom lift member by a U-shaped connector.

14. The foundation support installer of claim 13, the U-shaped connector connected to the boom lift member by a quick-release pin.

15. The foundation support installer of claim 11, the carriage pivotably connected to the boom such that the carriage is pivotable about two axes.

16. The foundation support installer of claim 11, the mount comprising a mount frame and a ring adjacent to the mount frame.

17. The foundation support installer of claim 16, the ring rotatable with respect to the mount frame.

18. The foundation support installer of claim 16, further comprising a hydraulic motor drive unit attached to the ring.

19. The foundation support installer of claim 18, further comprising a motor drive tool attached to the hydraulic motor drive unit.

20. The foundation support installer of claim 18, further comprising controls for the boom and the hydraulic motor drive unit, the boom comprising a boom lift member, the controls attached to the boom lift member.

21. The foundation support installer of claim 20, wherein the controls comprise a two spool valve.

22. The foundation support installer of claim 11, further comprising an electric winch attached to the mount.

23. The foundation support installer of claim 22, further comprising a battery for the electric winch, the battery attached to the base.

24. A foundation support installer, comprising:
a base;
a boom extending from the base, the boom comprising a boom lift member; and
a carriage comprising:
a carriage frame pivotably connected to the boom lift member;
a mount pivotably connected to the carriage frame, the mount comprising a mount frame and a ring adjacent to the mount frame, the ring rotatable; and
an electric winch attached to the mount frame.
